(19) United States
(12) Patent Application Publication
(10) Pub. No.: US 2004/0231470 A1
(43) Pub. Date: Nov. 25, 2004

(54) Protective socket having strengthened tool-drive hole

(76) Inventor: Peter Maznicki, Somers, CT (US)

Correspondence Address: Mark J. Schildkraut, Kaye Scholer LLP, 425 Park Avenue, New York, NY, 10022-3598, US

(21) Appl. No.: 10/444,587

(22) Filed: May 23, 2003

(51) Int. Cl. B25B 13/00

(52) U.S. Cl. 81/124.6

(57) ABSTRACT

A socket adapted to engage a socket drive tool and to torque a head of a hardware fastener includes a metallic outer sleeve and a non-metallic inner lining. The outer sleeve has an outer sleeve drive portion adapted to engage the socket drive tool, and an outer sleeve hardware portion attached to the outer sleeve drive portion. The inner lining is disposed within the outer sleeve hardware portion and has an inner lining drive portion adapted to engage the socket drive tool. The inner lining further includes an inner lining hardware portion attached to the inner lining drive portion, wherein the inner lining hardware portion includes a torquing hole, located at the distal end of the socket, and is sized to fit over the head of the hardware fastener to provide torque to the hardware fastener.

### FIELD OF THE INVENTION

The invention relates to sockets used for socket wrenches and the like, and more particularly to sockets which are designed to have increased torque value while reducing the likelihood of damage to hardware fasteners or components in communication thereof when torque is applied.

### BACKGROUND OF THE INVENTION

Metallic sockets have proven to be an effective tool for assembling and attaching apparatus components to one another. The use of these tools, however, through the application of torque, can damage or mar the hardware fasteners and components that are being assembled. For example, the corners on the head of a nut or bolt can be rounded off, the paint or coating can be damaged or scraped off the hardware fastener, or the component itself can be scraped or scratched as the socket twists against its surface.

Various non-metallic sockets, e.g., nylon, Teflon.R™, or other polymeric materials, have been utilized in an attempt to prevent the marring and damaging caused by metallic sockets. These non-metallic sockets require, however, a larger outside diameter than the metallic sockets in order to obtain the strength necessary to apply the proper torque to the hardware fastener during an assembly process. These larger outside diameters prevent the non-metallic sockets from fitting inside standard counter bores associated with the hardware fastener, e.g. a 3/8 inch bolt requires 0.620 inch diameter counter bore and 3/4 inch bolt requires a 1.120 inch diameter counter bore. On the other hand, if the non-metallic sockets outside diameter were made small enough to fit into the counter bores they would lack the strength of the metallic sockets and deform or slip when applying torque to the hardware fastener.

The accepted US standard for counter bore diameters for conventional socket wrenches, e.g. detachable socket wrenches with 1/4 inch and 3/8 inch square drives for hand use (manufactured to standard ASME B107.1-1993), is cited as follows: “Wrench Clearance, Table 3, SAE Aeronautical Drafting Manual, 1954 edition, page Y4.04” (hereinafter the “SAE Standard”). The standard is published by the SAE INTERNATIONAL, 400 Commonwealth Drive, Warrendale, Pa. 15096-0001. Column “A” of the SAE Standard gives the associated minimum counter bore diameters required to receive the nut drive end of the above referenced socket wrenches. The SAE Standard has been adapted and used by the machinery industry for many years and is printed in the 25th Edition of the “Machinery Handbook”, published by Industrial Press, Inc., New York, N.Y. (hereinafter the “Machinery Handbook”). Column “A” of the SAE Standard is printed as column “K” on page 1436 of the Machinery Handbook in Table 2, titled “Wrench Clearances for Open End Wrench 15 degrees and Socket Wrench (Regular Length)”. The socket wrench hardware fastener sizes and associated minimum counter bore diameters of Column “A” of the SAE Standard are reprinted in the following table:

| | Minimum |
|---|---|
| Hardware Fastener Size (inches) | Counter Bore Diameter (inches) |
| .188 | .370 |
| .250 | .470 |
| .312 | .550 |
| .344 | .580 |
| .375 | .620 |
| .438 | .750 |
| .500 | .810 |
| .562 | .870 |
| .594 | .920 |
| .625 | .950 |
| .688 | 1.030 |
| .750 | 1.120 |
| .781 | 1.150 |
| .812 | 1.200 |
| .875 | 1.280 |
| .938 | 1.370 |
| 1.000 | 1.470 |
| 1.062 | 1.550 |
| 1.125 | 1.610 |
| 1.250 | 1.890 |
| 1.312 | 1.980 |
| 1.438 | 2.140 |
| 1.500 | 2.200 |
| 1.625 | 2.390 |

Sockets made of non-metallic materials typically have a lower torque value, as compared to the torque value of metallic socket, for another reason. This lower torque value is due to the force communicated by the socket's tool-drive hole—i.e., the hole formed within the socket in which the wrench is inserted for driving such socket. The reduced torque value arises because the socket tool-drive hole which is made of a non-metallic material cannot withstand the same amount of force, without damage to the socket, that a socket made of a metal material can.

### SUMMARY OF THE INVENTION

Thus, it is an object of the invention to provide a socket that is made, at least in part, of a non-metallic material, wherein the socket has an outer sleeve and inner lining which—combined—have dimensions that substantially meet conventional socket wrench standards, and wherein the socket torque value is not reduced by the use of such non-metallic material.

In accordance with an embodiment of the invention, a socket adapted to engage with a socket drive tool and to torque a head of a hardware fastener includes a metallic outer sleeve and a non-metallic inner lining. The outer sleeve has an outer sleeve drive portion adapted to engage the socket drive tool, and an outer sleeve hardware portion attached to the outer sleeve drive portion. The inner lining is disposed within the outer sleeve hardware portion and has an inner lining drive portion adapted to engage the socket drive tool. The inner lining further includes an inner lining hardware portion attached to the inner lining drive portion, wherein the inner lining hardware portion includes a torquing hole, located at the distal end of the socket, and is sized to fit over the head of the hardware fastener to provide torque to the hardware fastener. The outer sleeve drive portion is configured to be situated adjacent to the inner lining drive portion and these drive portions are aligned to enable contemporaneous engagement with the socket drive tool.

In accordance with another embodiment of the invention, the inner lining further includes a stop adjacent to the inner lining drive portion which is configured for preventing the socket drive tool from entering the inner lining hardware portion.

### BRIEF DESCRIPTION OF THE DRAWING

Further objects, features and advantages of the invention will become apparent from the following detailed description taken in conjunction with the accompanying drawing showing illustrative embodiments of the invention, in which:

FIG. 1A is a side view of a protective socket in accordance with an embodiment of the invention;

FIG. 1B is a top view of a protective socket in accordance with an embodiment of the invention;

FIG. 1C is a bottom view of a protective socket in accordance with an embodiment of the invention;

FIG. 2A is a side view of the outer sleeve separated from the inner lining of the protective socket of FIGS. 1A-1C;

FIG. 2B is a top view of an outer sleeve of the protective socket of FIGS. 1A-1C;

FIG. 2C is a top view of an inner lining of the protective socket of FIGS. 1A-1C; and

FIG. 3 is a flowchart illustrating the process for manufacturing the protective socket of FIGS. 1A-1C, in accordance with an embodiment of the invention.

### DETAILED DESCRIPTION

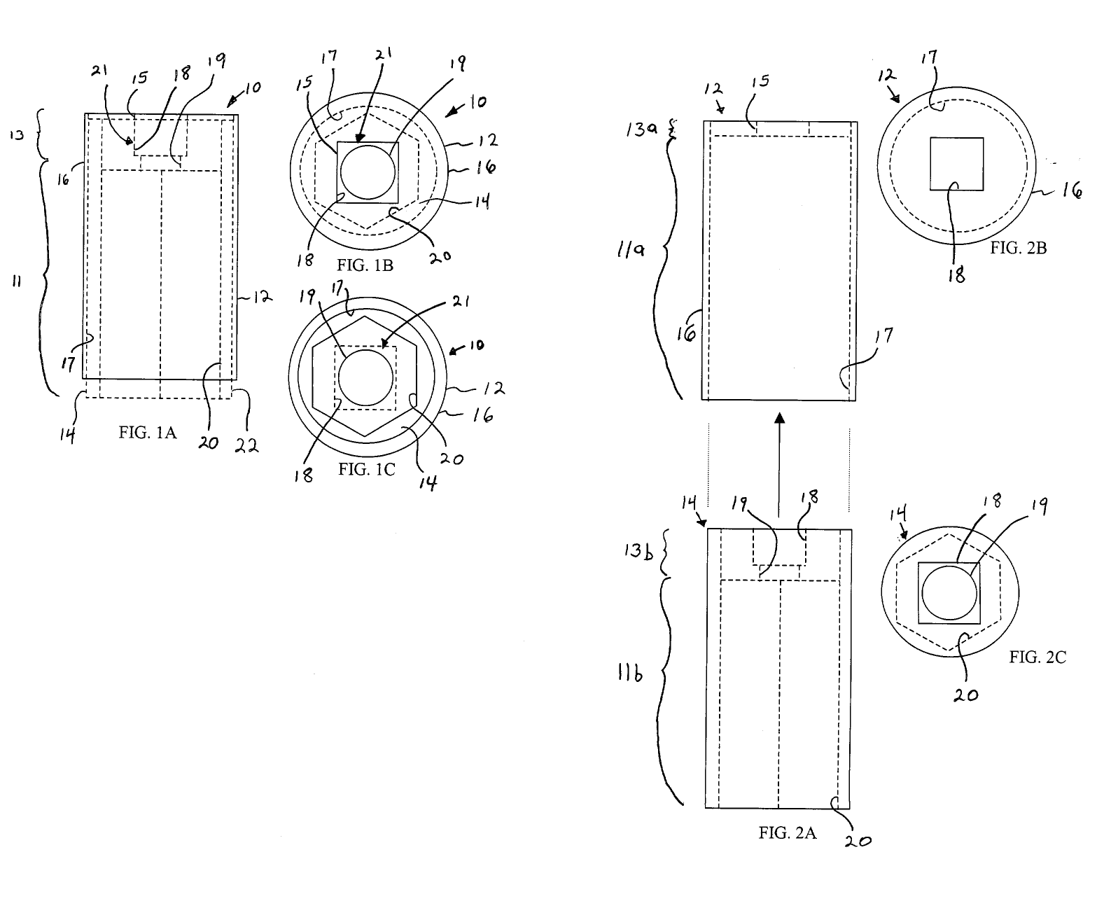

FIG. 1A illustrates a side view of protective socket 10 for torquing hardware fasteners, e.g., nuts and bolts, having strengthened tool-drive hole 21 in accordance with an embodiment of the invention. FIGS. 1B and 1C shows a top and bottom view, respectively, of protective socket 10. Protective socket 10 comprises socket hardware portion 11 adapted to engage the hardware fastener to be torqued and a socket drive portion 13 adapted to engage a conventional socket drive tool (not shown), e.g., a 1/4 inch, a 3/8 inch or a 1/2 inch hand socket drive tool. The hardware portion includes an outer sleeve 12 and an inner lining 14, which are individually shown (also in a side view) by FIG. 2A. FIGS. 2B and 2C show a top view of outer sleeve 12 (FIG. 2B) separated from inner lining 14 (FIG. 2C).

Referring to FIGS. 1A-1C, 2A and 2B, outer sleeve 12 is preferably constructed from a metallic material, e.g., stainless steel or hardened steel, to provide support for inner lining 14. Outer sleeve 12 has an outside diameter, indicated by numeral 16, sized to fit inside of standard counter bore holes of the associated hardware fasteners being torqued, e.g., counter bore holes sized to meet the SAE Standard. Outer sleeve 12 is shown, by way of example, as cylindrical in shape having a circular inside portion 17 and extending into outer sleeve drive portion 13a of outer socket 12.

Outer sleeve drive portion 13a of outer sleeve 12 has an outer sleeve tool-drive hole 15. Outer sleeve tool-drive hole 15 is sized to fit over the socket drive of a tool used to apply torque to the hardware fastener being assembled. Outer sleeve tool-drive portion 15 is shown, by way of example, as being generally square in shape and is sized to mate with a standard square socket drive, such as a 1/4 inch, 3/8 inch or 1/2 inch drive. One skilled in the art would recognize that tool-drive hole 15 may comprise other shapes to fit over other socket drives, e.g., metric drives or nonstandard shaped drives. Outer sleeve tool-drive hole 15 contributes to the formation of protective socket tool-drive hole 21, which in accordance with an embodiment of the invention is made up of outer sleeve tool-drive hole 15, and inside lining tool-drive hole 18, as further described below.

As shown by FIGS. 1A-1C and 2A-2C, inside portion 17 of outer sleeve 12 mates concentrically with inner lining 14 to provide support for inner lining 14 during the torquing process. One skilled in the art would recognize that inside portion 17 may comprise other shapes while still providing support to the inner lining 14. That is, inside portion 17 may have different shapes to provide different degrees of support for inner lining 14. In such instances, the shape of inner lining 14 would, in turn, be modified to mate with inside portion 17 and continue to provide a protective lining for hardware fasteners and components being assembled.

Inner lining 14 includes a hardware fastener torquing hole 20. Hardware fastener torquing hole 20 is shown, by way of example, as being hexagonal in shape having 6 points (or single hexagonal) to fit over a standard six-point hex head bolt or nut. However, one skilled in the art would recognize that hardware fastener torquing hole 20 may comprise other shapes to fit over other types of hardware fastener, e.g., double hexagonal, square or double square.

Inner lining 14 is preferably constructed from a composite material having an M scale hardness of substantially 115 or greater, e.g., NEMA grade G-10 glass cloth epoxy or NEMA grade G-3 glass cloth phenolic. The unique combination of the inner lining 14 supported by outer sleeve 12 provides the necessary strength and rigidity to apply the proper torque required to hardware in most assembly processes. Additionally, the inner lining 14 is pliable enough to prevent marring or damaging of the hardware fastener being torqued or the components assembled.

In the exemplary embodiment shown, inner lining 14 further includes an extended portion 22 which extends outwardly from outer sleeve 12 at the distal end of protective socket 10 containing hardware fastener torquing hole 20. Extended portion 22 prevents outer sleeve 12 from making contact with any component that socket 10 torques hardware fasteners onto. This provides additional protection to the surface of the component by ensuring that only the pliable inner lining 14 can make contact with the surface, thus preventing scraping or scratching of the component with the metal outer sleeve 12.

If the extended portion 22 extends outwardly from the distal end of the outer sleeve by more than a thickness of the head of the hardware fastener (not shown), then the extended portion may deform or slip when applying torque to the hardware fastener. That is, the head of the hardware fastener will pull out of the outer sleeve as it is torqued flush to the surface of the component being torqued, and be supported solely be the inner lining. Therefore, in this exemplary embodiment, the extended portion extends outwardly from the distal end of the outer sleeve by a distance less then the thickness of the head of the hardware fastener it is torquing.

Inner lining drive portion 13b of inner lining 14 includes inner lining tool-drive hole 18. Inner lining tool-drive hole 18 is sized to fit over the socket drive of a tool used to apply torque to the hardware fastener being assembled. Inner lining tool-drive portion 18 is shown, by way of example, as being generally square in shape and is sized to mate with a standard square socket drive, such as a 1/4 inch, 3/8 inch or 1/2 inch drive. One skilled in the art would recognize that tool-drive hole 18 may comprise other shapes to fit over other socket drives, e.g., metric drives or nonstandard shaped drives.

Outer sleeve tool-drive hole 15 and inner lining tool-drive hole 18 are, in accordance with an embodiment of the invention, substantially the same shape and form a hole of uniform size (e.g., diameter or length and width) and are therefore configured to similarly engage a socket tool. In addition, inner lining 14 includes stop 19 which is situated adjacent to and below inner lining tool-drive hole 18. Stop 19 is formed to prevent the socket tool from entering past the drive portion 13 of protective socket 10 and into hardware portion 11. By configuring inner lining 17 with a stop that is laterally smaller in size than inner lining tool-drive hole 18 and outer sleeve tool-drive hole 15, a socket tool may enter drive portion 13 of protective socket 10, but not hardware portion 11.

Thus, in the embodiment illustrated by FIGS. 1A-1C and 2A-2C, because stop 19 is formed by a circle having a diameter that is smaller than the length of the edges of outer sleeve tool-drive hole 15 and inner lining tool-drive hole 18, a socket tool that is substantially the same size as holes 15 and 18, albeit smaller, can enter these holes, but cannot enter hardware portion 11 of protective socket 10. It should be noted that inner lining 14 may be devised to form stops of various shapes and/or size for preventing a tool that is inserted into driving portion 13 of protective socket 10 from entering into hardware portion 11.

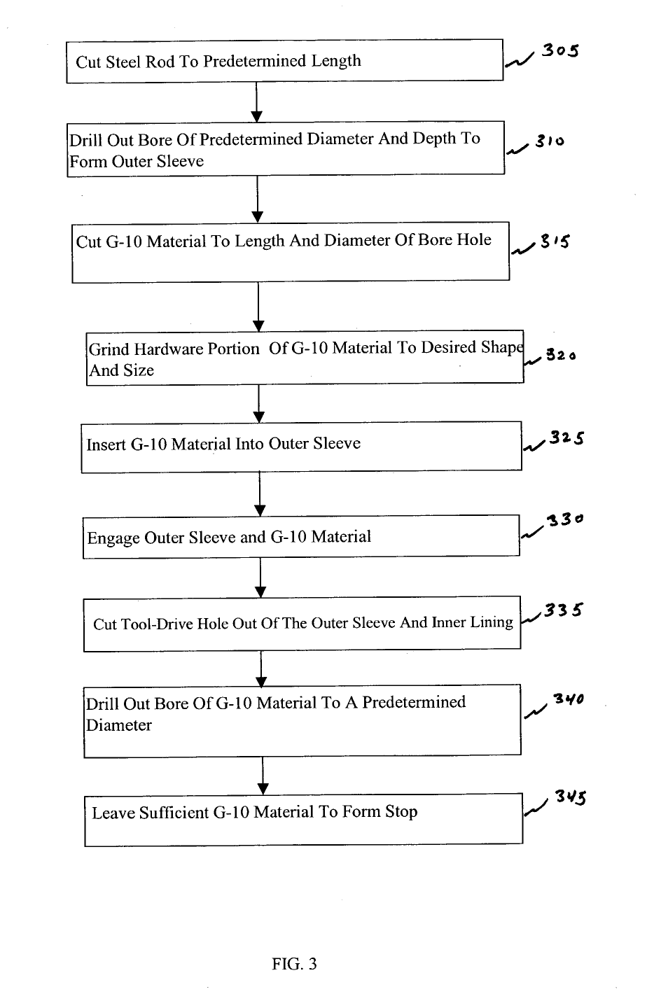

FIG. 3 is a flowchart which illustrates the process for manufacturing protective socket 10, in accordance with an embodiment of the invention. In this example, protective socket 10 comprises a stainless steel outer sleeve 12 having a 13/16 inch outer diameter 16, a 3/4 inch inner diameter 17, 1½ inch outer sleeve hardware portion 11a, a 1/8 inch outer sleeve drive portion 13a, and a 3/8 inch by 3/8 inch square outer sleeve tool-drive hole 15. In addition, suppose inner lining 14 is made of G-10 material having a 3/4 inch outer diameter, a ½ inch hexagonal hardware fastener torquing hole 20, a 1¼ inch inner lining hardware portion 13b and 5/16 inch inner lining drive portion 13b, wherein the inner lining drive portion 13b comprises a 3/8 inch by 3/8 inch square outer sleeve tool-drive hole having a ¼ inch depth. Inner lining hardware portion 11b further includes a stop having a ¼ inch inner diameter.

In this example, a solid stainless steel rod having a 13/16 diameter (i.e., matching outer diameter 16 of outer sleeve 12) is selected and is cut to a predetermined length (step 305) which in this case is 1-5/8 inch (i.e., the length of outer sleeve hardware portion 11a and outer sleeve drive portion 13a combined). At step 310, the bore of the cut steel rod is drilled out to form outer sleeve 12 having a 3/4 inch inner diameter 17. The bore is not is not extended completely through the steel rod; instead, the bore terminates 1/8 inch from the end of the cut steel rod. The remaining 1/8 inch section forms drive portion 13a of outer sleeve 12.

At step 315, G-10 material having a 3/4 inch diameter is then cut to a predetermined length—in this case, 1 and 9/16 inches—to form inner lining 14. At step 320, inner lining hardware portion 11b of the G-10 material is ground to meet the desired shape and dimensions of torquing hole 20—in this example, a ½ inch hexagonal hardware fastener torquing hole. The solid G-10 material is then inserted into outer sleeve 12 (step 325) and outer sleeve 12 and inner lining 14 are engaged by a broaching machine (step 330) for establishing tool-drive hole 21 (step 335). In accordance with an embodiment of the invention, the broaching machine is configured for cutting into the drive portion of both the outer sleeve 12 and inner lining 14—in one step—such that outer sleeve tool-drive hole 15 and the inner lining tool-drive hole 18 are substantially the same shape and size—in this case a square having 3/8 inch sides.

Next, hardware portion 11b of inner sleeve 14 is formed. This is accomplished by drilling out a bore through the hardware portion 11b of the G-10 material up to a point before which the drive portion 13b begins (step 340). At this point (step 345), stop 19 is formed. Stop 19 is the portion of G-10 material that remains between the bore of hardware portion 11 and the bottom of the inner lining tool-drive hole 18. In this example, a 1/4 inch bore is drilled out of the center of stop 19. Because the diameter of the stop (1/4 inch) is less than the 3/8 inch sides of square socket tool-drive hole 21, stop 19 prevents the socket tool from entering socket hardware portion 11 upon insertion of such tool into socket driver portion 13.

The foregoing merely illustrates the principles of the invention. It will thus be appreciated that those skilled in the art will be able to devise numerous other arrangements which embody the principles of the invention and are thus within its spirit and scope.

For example, although the embodiment illustrated herein shows a drive hole that is square and a hardware fastener torquing hole as being hexagonal, sockets may be manufactured having different dimensions and shapes. Thus, a socket employing the principles described herein may be manufactured to the sizes and shapes described by one of the following standards: standard ASME B107.1-1993, entitled “Socket Wrenches, Hand (Inch Series)” and standard ASME B107.5M-1994, entitled “Socket Wrenches, Hand (Metric Series)”—both of which are published by the American Society of Mechanical Engineers.

Further, although outer sleeve 12 is made of stainless steel, other materials, such as tool steel, may be used in its place. Moreover, in addition to using NEMA grade G-10 glass cloth epoxy or NEMA G-3 glass cloth phenolic to form inner lining 14, other types of material, in particular molded material, may be used.

What is claimed is:

1. A socket adapted to torque a head of a hardware fastener, comprising:
a metallic outer sleeve having:
an outer sleeve drive portion having an outer sleeve tool-drive hole, wherein the outer sleeve tool-drive hole is adapted to engage a socket drive tool, and
an outer sleeve hardware portion attached to the outer sleeve drive portion; and
a non-metallic inner lining to be disposed within the outer sleeve hardware portion, the inner lining having:
an inner lining drive portion having an inner lining tool-drive hole, wherein the inner lining tool-drive hole is adapted to engage the socket drive tool, and
an inner lining hardware portion attached to the inner lining drive portion, the inner lining hardware portion including a torquing hole, located at the distal end of the socket, sized to fit over the head of the hardware fastener to provide torque to the hardware fastener.

2. The socket of claim 1, wherein the outer sleeve tool-drive hole is adjacent to the inner lining tool-drive hole and are aligned to enable engagement with the socket drive tool.

3. The socket of claim 1, wherein the inner lining further includes a stop adjacent to the inner lining drive portion and is configured for preventing the socket drive tool from entering the inner lining hardware portion.

4. The socket of claim 1, wherein the inner lining substantially has an M scale hardness of at least 115.

5. The socket of claim 1, wherein the inner lining comprises a composite material.

6. The socket of claim 1, wherein the inner lining comprises one of the group consisting of NEMA Grade G-10 glass cloth epoxy and NEMA Grade G-3 glass cloth phenolic.

7. The socket of claim 1, wherein the inner lining hardware portion is has a cross sectional shape configured as one of the group consisting of a single hexagon, double hexagon, square and double square.

8. The socket of claim 1, wherein the inner lining hardware portion is configured for extending outwardly from the distal end of the outer sleeve by a distance less than a thickness of the head of the hardware fastener.

9. The socket of claim 1, wherein the outer sleeve tool-drive hole and the inner lining tool-drive hole are adapted to engage one of the group consisting of a 1/4 inch socket drive tool, a 3/8 inch socket drive tool and a 1/2 inch socket drive tool.

10. The socket of claim 1, wherein the outer sleeve drive portion has an outside diameter different than that of the outer sleeve hardware portion.

11. The socket of claim 1, wherein the outer sleeve drive portion and the outer sleeve hardware portion are pivotally attached.

12. A socket adapted to torque a head of a hardware fastener, the hardware fastener having a predetermined size and an associated counter bore with a predetermined diameter per SAE Standard cited as: “Wrench Clearance, Table 3, SAE Aeronautical Drafting Manual, 1954 edition, page Y4.04”, the socket comprising:
a metallic outer sleeve having an outside diameter which is sized to fit into the associated counter bore of the hardware fastener, the outer sleeve including:
an outer sleeve drive portion having an outer sleeve tool-drive hole, wherein the outer sleeve tool-drive hole is adapted to engage a socket drive tool, and
an outer sleeve hardware portion attached to the outer sleeve drive portion; and
a non-marring inner lining to be disposed within the outer sleeve hardware portion, the inner lining including:
an inner lining drive portion having an inner lining tool-drive hole, wherein the inner lining tool-drive hole is adapted to engage the socket drive tool, and
an inner lining hardware portion attached to the inner lining drive portion, the inner lining hardware portion including a torquing hole, located at the distal end of the socket, sized to fit over the head of the hardware fastener to provide torque to the hardware fastener, without marring the hardware fastener.

13. The socket of claim 12, wherein the outer sleeve tool-drive hole is adjacent to the inner lining tool-drive hole and are aligned to enable engagement with the socket drive tool.

14. The socket of claim 12, wherein the inner lining further includes a stop adjacent to the inner lining drive portion and is configured for preventing the socket drive tool from entering the inner lining hardware portion.

15. The socket of claim 12, wherein the inner lining substantially has an M scale hardness of at least 115.

16. The socket of claim 12, wherein the inner lining comprises a composite material.

17. The socket of claim 12, wherein the inner lining comprises one of the group consisting of NEMA Grade G-10 glass cloth epoxy and NEMA Grade G-3 glass cloth phenolic.

18. The socket of claim 12, wherein the inner lining hardware portion is has a cross sectional shape configured as one of the group consisting of a single hexagon, double hexagon, square and double square.

19. The socket of claim 12, wherein the inner lining hardware portion is configured for extending outwardly from the distal end of the outer sleeve by a distance less than a thickness of the head of the hardware fastener.

20. The socket of claim 12, wherein the outer sleeve tool-drive hole and the inner lining tool-drive hole are adapted to engage one of the group consisting of a 1/4 inch socket drive tool, a 3/8 inch socket drive tool and a 1/2 inch socket drive tool.

21. The socket of claim 12, wherein the outer sleeve drive portion has an outside diameter different than that of the outer sleeve hardware portion.

22. The socket of claim 12, wherein the outer sleeve drive portion and the outer sleeve hardware portion are pivotally attached.

23. The socket of claim 12, wherein the socket has dimensions which substantially meet one of the standards ASME B107.1-1993 and ASME B107.5M-1994 for the size of the hardware to be torqued.

24. The socket of claim 1 wherein the predetermined size of the hardware fastener and the predetermined minimum counter bore diameter respectively are substantially equal to one of the pairs of hardware sizes and associated minimum counter bore diameters listed in the following table:

| Hardware size (inches) | Minimum Counter Bore Diameter (inches) |
|---|---|
| .188 | .370 |
| .250 | .470 |
| .312 | .550 |
| .344 | .580 |
| .375 | .620 |
| .438 | .750 |
| .500 | .810 |
| .562 | .870 |
| .594 | .920 |
| .625 | .950 |
| .688 | 1.030 |
| .750 | 1.120 |
| .781 | 1.150 |
| .812 | 1.200 |
| .875 | 1.280 |
| .938 | 1.370 |
| 1.000 | 1.470 |
| 1.062 | 1.550 |
| 1.125 | 1.610 |
| 1.250 | 1.890 |
| 1.312 | 1.980 |
| 1.438 | 2.140 |
| 1.500 | 2.200 |
| 1.625 | 2.390. |

25. A method for manufacturing a socket, having a metallic outer sleeve and a non-metallic inner lining, the socket adapted to engage with a socket drive tool and to torque a head of a hardware fastener, comprising:
disposing a non-metallic inner lining within a metallic outer sleeve;
engaging the metallic outer sleeve and non-metallic inner lining for establishing an outer sleeve tool-drive hole in the metallic outer sleeve and an inner lining tool-drive hole in the non-metallic inner lining; and
cutting into a distal end of the metallic outer sleeve and non-metallic inner lining to establish the outer sleeve tool-drive hole and the inner lining tool-drive hole.

26. The method of claim 25, wherein the outer sleeve tool-drive hole has a shape and size that is substantially the same as that of the inner lining tool-drive hole.

27. A method for manufacturing a socket adapted to engage with a socket drive tool and to torque a head of a hardware fastener, comprising:
forming a metallic outer sleeve having an outer sleeve drive portion adapted to engage a socket drive tool and an outer sleeve hardware portion attached to the outer sleeve drive portion;
forming a non-metallic inner lining to be disposed within the outer sleeve hardware portion, the inner lining having an inner lining drive portion to engage the socket drive tool and an inner lining hardware portion attached to the inner lining drive portion;
disposing the non-metallic inner lining within the metallic outer sleeve;
engaging the metallic outer sleeve and non-metallic inner lining for establishing a socket tool-drive hole in the metallic outer sleeve and non-metallic inner lining; and
cutting into a distal end of the metallic outer sleeve and a distal end of the non-metallic inner lining to establish the torquing hole.

28. The method of claim 27, wherein the socket tool-drive hole comprises an outer sleeve tool-drive hole formed by cutting into the distal end of the outer sleeve and an inner lining tool-drive hole formed by cutting into the distal end of the non-metallic inner lining.
